(19) United States
(12) Patent Application Publication
(10) Pub. No.: US 2014/0250853 A1
(43) Pub. Date: Sep. 11, 2014

(54) MECHANICAL BERRY HARVESTER

(71) Applicant: DOLE FRESH VEGETABLES, INC., Salinas, CA (US)

(72) Inventors: Terry YOUNG, Sunnyvale, TX (US); Stephen JENS, Winchester, MA (US); Art CASTRO, Hollister, CA (US); Robert STOUDT, Salinas, CA (US)

(73) Assignee: DOLE FRESH VEGETABLES, INC., Salinas, CA (US)

(21) Appl. No.: 13/794,642

(22) Filed: Mar. 11, 2013

(51) Int. Cl. A01D 46/26

(52) U.S. Cl. CPC A01D 46/26
USPC 56/329

(57) ABSTRACT

A mechanical berry harvester and a method for harvesting berries in the field is provided. The mechanical harvester includes a framework, collectors, spring elements, pulleys and belts. The collectors are configured to collect berries fallen from branches of the berry bush. Each spring element is connected to the framework and a collector. Each pulley is connected to a spring element and a collector. Each belt has an inner face and an outer face, and the inner faces of the belts are in contact with the pulleys. When the trunk of a berry bush comes in contact with a portion of the adjacent belts, the spring element(s) connected to the portions of the adjacent belts in contact with the trunk are each configured to independently compress and create a gap between the adjacent belts.

### BACKGROUND

1. Field

The present disclosure relates generally to commercial berry harvesting in the field, and more specifically to a mechanical harvester and method for mechanically harvesting berries from a row of berry bushes in the field.

2. Related Art

Berries are generally very delicate and bruise easily. As a result, commercial harvesting of berries has traditionally been a manual process. Field workers walk through the rows of berry bushes in the field, hand-picking berries one by one or a few at a time.

Mechanical harvesters have been used to replace this labor-intensive process. Conventional berry harvesters usually use rods that shake the bushes, and catcher plates to collect the fallen berries. However, such conventional berry harvesters typically damage the berry bushes, and berries can easily bruise from falling onto hard surfaces and edges of the catcher plates. Additionally, berries may drop to the ground through gaps between the catcher plates of the mechanical harvester. Berries that drop to the ground are not typically recovered, and the decrease in harvesting yield may be significant depending upon the size of the gaps.

Thus, what is needed in the art is an improved mechanical berry harvester that can maximize the amount of berries harvested and collected, while minimizing the damage, such as bruising, to the harvested berries.

### BRIEF SUMMARY

In one exemplary embodiment, a mechanical harvester for harvesting berries from bushes in a field is provided. The bush has a trunk, branches connected to the trunk, and berries attached to the branches. The mechanical harvester includes a framework, collectors, spring elements, pulleys, and belts. The collectors are configured to collect berries fallen from branches of the bush. The spring elements are connected to the framework and the collectors. The pulleys are connected to the spring elements and the collectors. The belts each have an inner face and an outer face. The inner face of each belt is in contact with the pulleys, while the outer faces of adjacent belts come into contact with a trunk of a bush, when present. When a trunk is in contact with a portion of adjacent belts, the spring element(s) connected to the portions of the adjacent belts in contact with the trunk are each configured to independently compress and create a gap between the adjacent belts. The mechanical harvester may additionally include a shaking apparatus configured to shake the bush in contact with the mechanical harvester, and one or more air blowers configured to the fallen berries towards to the collectors and to minimize the loss of the berries falling onto the ground during the harvesting process.

Also provided is a method for harvesting berries from a bush in a field using the mechanical harvester described above. The method includes contacting a portion of the adjacent belts with a trunk of a bush; independently compressing the spring elements, connected to the portions of the adjacent belts in contact with the trunk, to create a gap between the adjacent belts; and collecting the fallen berries. The contacting of the mechanical harvester with the bush causes berries on the branches of the bush to fall onto the collectors.

### DESCRIPTION OF THE FIGURES

The present application can be best understood by references to the following description taken in conjunction with the accompanying figures, in which like parts may be referred to by like numerals:

FIGS. 1A and 1B depict aerial-front and aerial-side views, respectively, of an exemplary embodiment of a mechanical harvester in contact with a berry bush.

FIG. 2 depicts a front view of a system of collectors, spring elements, pulleys and belts of the exemplary mechanical harvester.

FIGS. 3A and 3B depict top and bottom views, respectively, of the system of collectors, spring elements, pulleys and belts of the exemplary mechanical harvester.

FIGS. 4A and 4B depict bottom-front and bottom-side views, respectively, of the exemplary embodiment of the mechanical harvester in contact with a berry bush.

FIG. 5 depicts another exemplary embodiment of a mechanical harvester configured with a shaking apparatus.

FIG. 6 depicts yet another exemplary embodiment of a mechanical harvester configured with an air blower.

FIG. 7 is a flow chart depicting an exemplary method for harvesting berries from a berry bush in a field.

### DETAILED DESCRIPTION

To provide a more thorough understanding of the present invention, the following description sets forth numerous specific details, such as specific configurations, parameters, examples, and the like. It should be recognized, however, that such description is not intended as a limitation on the scope of the present invention but is intended to provide a better description of exemplary embodiments.

The following description relates primarily to a mechanical harvester used in the commercial harvesting of berries that grows on bushes. Such berries may include, for example, blueberries, raspberries, and blackberries. Berry bushes are typically planted in rows in a field. Berries grow from the branches of the bushes. The branches are connected to the trunk of the bushes, and the trunk is connected to stems in the ground.

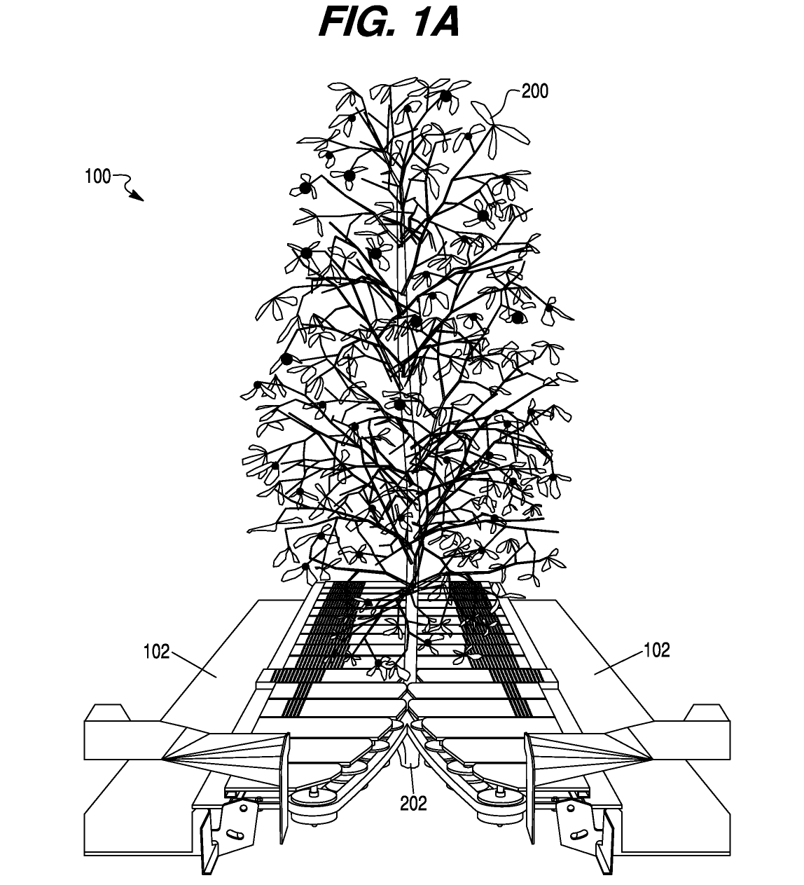

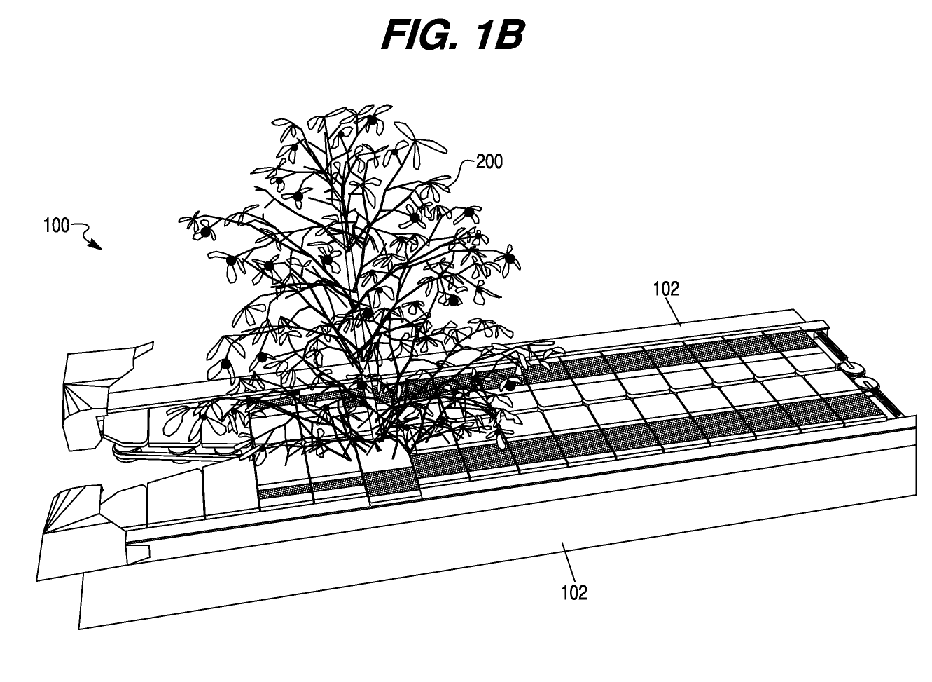

With reference to FIGS. 1-4, an exemplary mechanical harvester 100 is depicted. As described below, mechanical harvester 100 harvests berries by moving through a row of bushes in the field. As mechanical harvester 100 comes in contact with the trunk of a berry bush, the berries fall from branches of the bush. The fallen berries are collected using a system of collectors, spring elements, pulleys and belts, configured to minimize the damage to the bushes, the damage to berries falling onto the collectors, and the number of the berries that may be lost to the ground in the harvesting process.

The mechanical harvester includes a framework, collectors configured to collect berries fallen from branches of a bush, spring elements connected to the framework and the collectors, pulleys connected to the spring elements and the collectors, and belts in contact with the pulleys. Each of these parts of the mechanical harvester are described in further detail below.

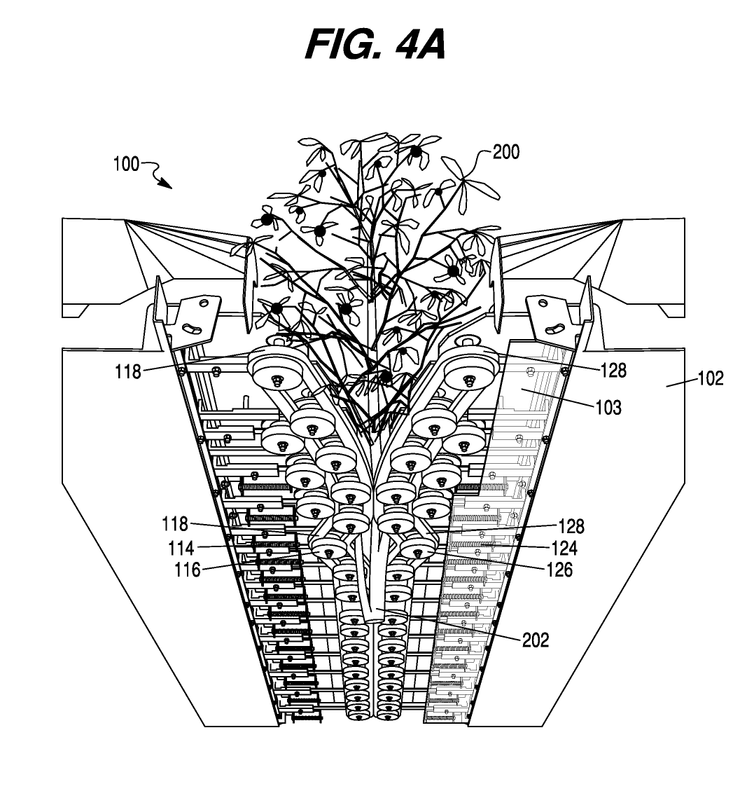

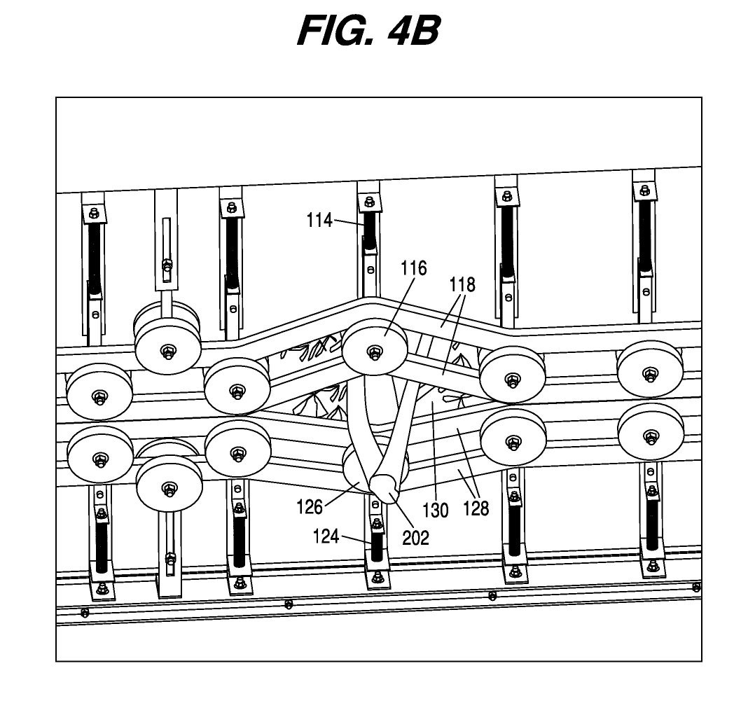

With reference to FIGS. 1A and 1B, framework 102 connects the collectors, spring elements, pulleys and belts. Although not depicted in this figure, it should be understood that framework 102 is supported for movement across the field. For example, framework 102 may include wheels. In one embodiment, framework 102 may be pulled by a vehicle. In another embodiment, framework 102 may be part of an automated vehicle that moves through the field. The mechanical harvester may also include skid plate 103 connected to framework 102, as depicted in FIG. 4A, to prevent damage to the underside of the mechanical harvester when contact is made with the ground. The skid plate may be made of any suitable material, such as abrasion-resistant material.

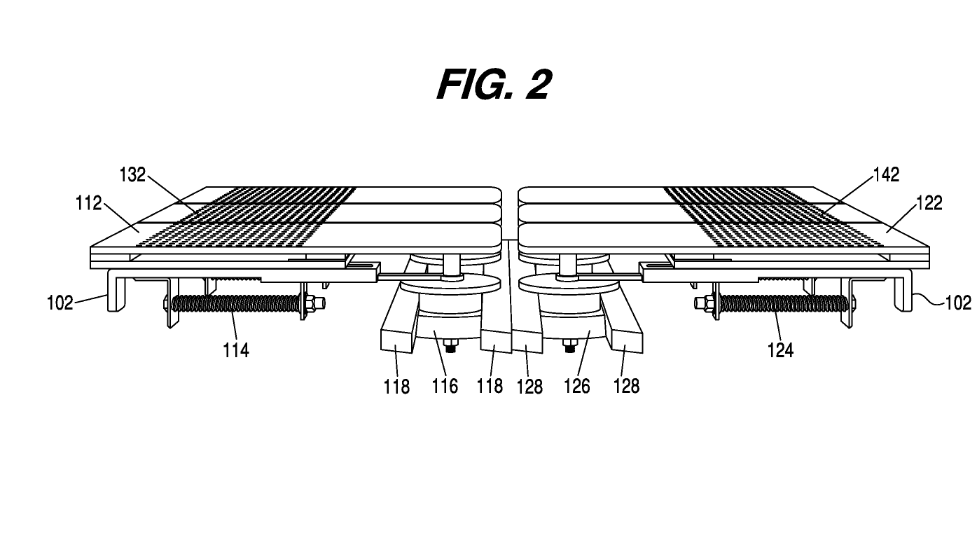

With reference to FIG. 2, in the present embodiment, the mechanical harvester has a left set and a right set of collectors, spring elements, pulleys and belts. For example, on the left side of the mechanical harvester (as depicted in the figure), mechanical harvester 100 includes collector 112, spring element 114, pulley 116, and belt 118. Spring element 114 is connected to framework 102 and collector 112. Pulley 116 is connected to spring element 114 and collector 112. Similarly, on the right side of the mechanical harvester (as depicted), mechanical harvester 100 includes collector 122, spring element 124, pulley 126, and belt 128. Spring element 124 is connected to framework 102 and collector 122. Pulley 126 is connected to spring element 124 and collector 122.

The collectors and belts are typically made of pliable material. For example, the collectors may be made of plastic or rubber. Any pulleys suitable for supporting the belts may be used in the mechanical harvester. It should be understood, however, that in other exemplary embodiments, the mechanical harvester may use a low friction guide in place of the pulleys.

Additionally, any suitable spring elements that can compress and relax may be used in the mechanical harvester. While FIGS. 2, 3B, 4A and 4B of the present embodiment of the mechanical harvester depict the use of compression springs, it should be understood that other spring elements may include tension springs, leaf springs, gas springs, air springs, elastomers, and bungee cords.

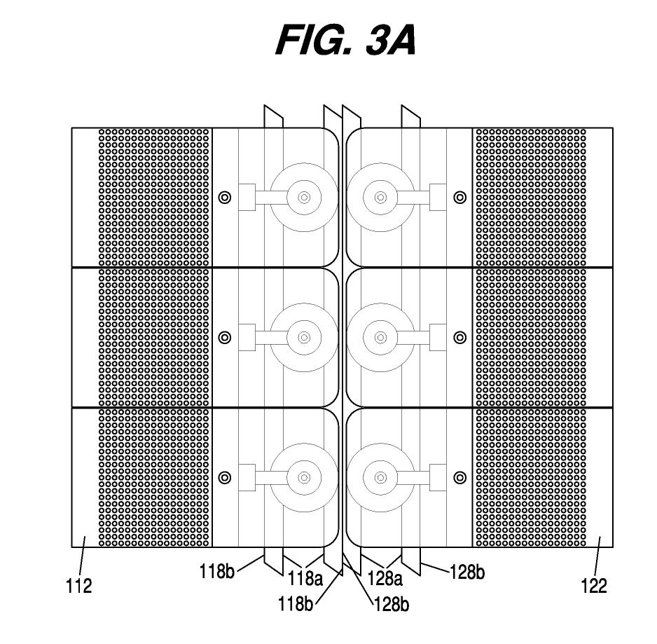

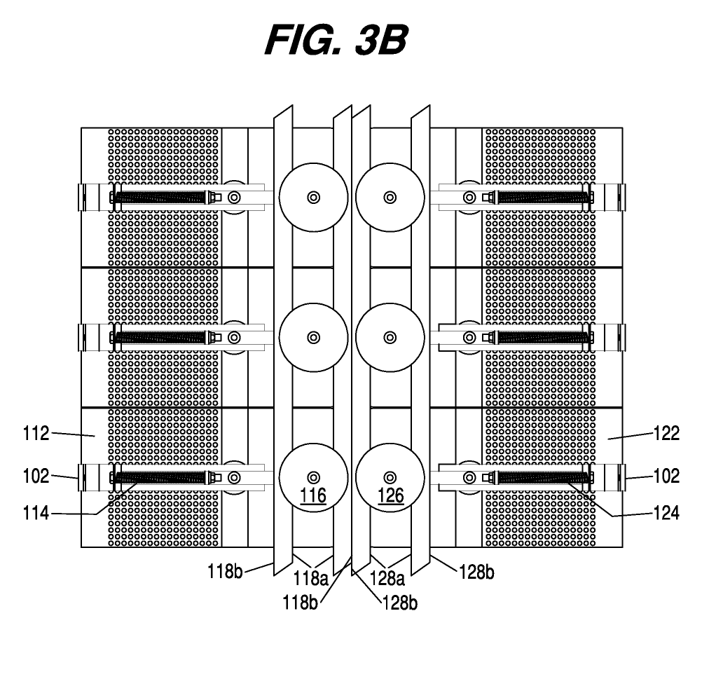

As depicted in FIGS. 3A and 3B, belt 118 has inner face 118a and outer face 118b, and belt 128 has inner face 128a and outer face 128b. Inner faces 118a and 128a are each in contact with the pulleys. For example, a portion of inner face 118a is in contact with pulley 116, and a portion of inner face 128a is in contact with pulley 126. Outer faces 118b and 128b are adjacent to each other, and come in contact with the trunk of a berry bush, when present. As depicted in FIGS. 3A and 3B, when the trunk of a berry bush is not present, outer faces 118b and 128b are in contact with each other.

As the mechanical harvester comes in contact with a berry bush, the trunk of the bush is positioned between the belts. With reference to FIGS. 4A and 4B, when mechanical harvester 100 comes in contact with bush 200, trunk 202 of the bush is positioned between belts 118 and 128. Trunk 202 exerts a force on spring elements 114 and 124, causing each of these spring elements to compress. When spring elements 114 and 124 compress, collectors 112 and 122 to move apart to form gap 130, as depicted in FIG. 4B. The gap that forms helps to minimize damage to trunk 202 as bush 200 comes in contact with mechanical harvester 100. The size of gap 130 may be also configured to minimize the number of the berries that may fall onto the ground in the harvesting process.

With reference again to FIG. 4A, as mechanical harvester 100 moves forward through a row of bushes in the field, trunk 202 comes into contact with a second portion of belts 118 and 128. While not depicted in the figures, another set of spring elements will each independently compress, causing another set of collectors to move apart and to form another gap. Once trunk 202 is not longer in contact with the first portion of belts 118 and 128, spring elements 114 and 124 independently relax, thereby causing collectors 112 and 122 to come back together. The formation of a gap between the portions of the belts in contact with the trunk of the bush helps to minimize the number of berries that may be lost to the ground in the harvesting process.

The contact of the trunk with the belts of the mechanical harvester causes berries to fall onto the collectors of the mechanical harvester. In other exemplary embodiments, the mechanical harvester may further include a shaking apparatus. The shaking apparatus may be connected to the framework, and is configured to shake the bush in contact with the mechanical harvester.

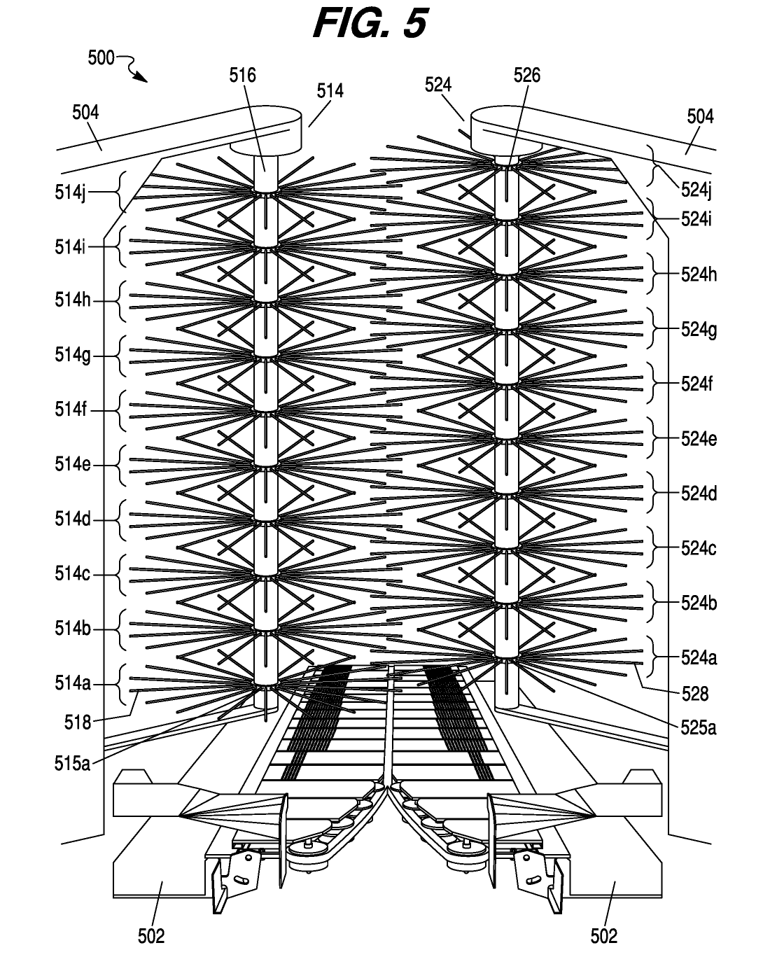

With reference to FIG. 5, in another exemplary embodiment, mechanical harvester 500 is depicted with shaking apparatus 504 attached to framework 502. Shaking apparatus 504 includes shaking units 514 and 524 (left and right, respectively, as depicted in FIG. 5). Each shaking unit includes clusters of rods radiating from a support column connected to framework 502. Each rod cluster includes a series rods radiating from the support column. The rods can be connected to a rotating unit on the support column that allows the rods of that cluster to rotate when the shaking unit comes into contact with a bush as the mechanical harvester moves forward in the field. For example, shaking unit 514 includes rod clusters (514a-j) radiating from support column 516. Rod cluster 514a, for example, has rods 518 that are radially configured and attached to rotating unit 515a on support 516. Similarly, shaking unit 524 includes rod clusters (524a-j) radiating from support column 526. Rod cluster 524a, for example, has rods 528 that are radially configured and attached to rotating unit 525a on support 526.

As depicted in FIG. 5, these rod clusters may be vertically arranged, one above each other, along the support column. Since each rod cluster (as depicted in FIG. 5) is connected to a different rotating unit, the rod clusters connected to the same support column can independently rotate as each rod cluster comes into contact with the bush.

When a bush comes into contact with the shaking apparatus of the mechanical harvester, one or more of the rod clusters independently rotate around the support column to which they are connected, thereby shaking the bush and causing at least some of the berries to fall from the bush. For example, as mechanical harvester 500 moves forward in the field and a bush comes into contact with rod cluster 514a and 524a, each rod cluster is configured to independently rotate around the support column to which the rod clusters are connected. The rotational movement of the rods in the cluster shakes the branches of the bush, causing at least of the berries to fall. It should be understood, however, in other exemplary embodiments, the rod clusters may be fixed directly to the support column, and do not rotate upon contact with the bush. Additionally, it should be understood that some of the rod clusters may not come into contact with bushes, depending on the height of the bushes in the field.

While two shaking units (one on the left and one on the right of mechanical harvester 500) are depicted in FIG. 5, it should be understood that that the mechanical harvester may have one or more additional shaking units on either or both sides of the mechanical harvester. Additionally, the number of rod clusters, the number of rods in each rod cluster, and the distance between each rod cluster on a support column may vary, for example, depending on the height of the berry bush. The rods may be made of any material suitable for minimizing damage to the berries and berry bush. For example, the rods may be made of a pliable material (e.g., plastic or rubber), or the rods may be made of metal and coated with rubber.

While FIGS. 1-5 depict the collectors as plates, it should be understood that in other exemplary embodiments, the collectors may be containers. For example, the collectors may be bins. Additionally, some or all of the collectors may have air vents configured to have air blowing upwards to further minimize the impact of the berries falling down onto the collectors. For example, as depicted in FIG. 2, collectors 112 and 122 have air vents 132 and 142, respectively. When air vents are present on the collectors, an air source is typically found the bottom-side of the collectors. The air source is configured to gently blow air upwards through the air vents, to soften the impact of the berries falling from the branches onto the collectors. The air source may be an air blower.

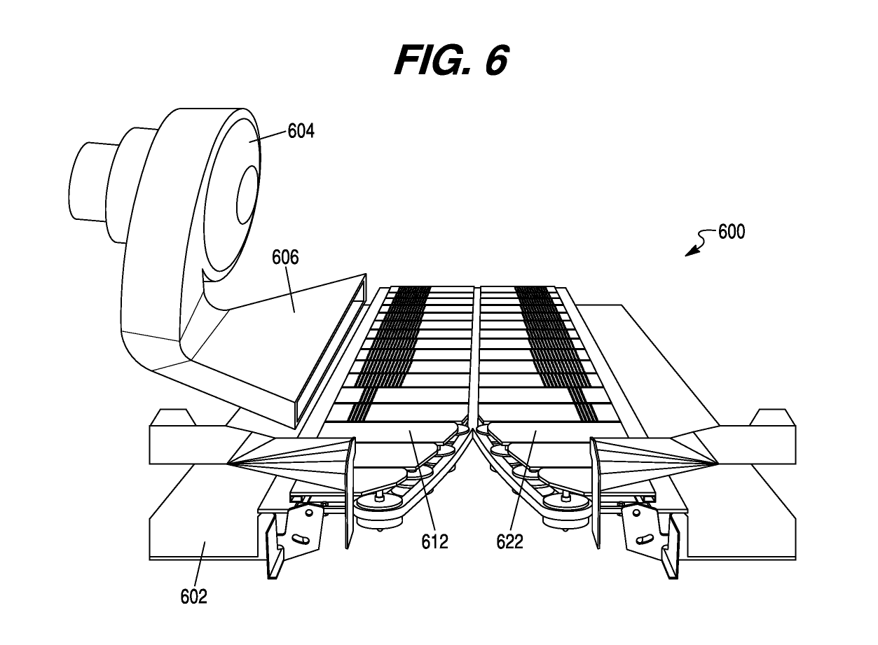

An air source may also be positioned near the collectors, blowing air from the side of mechanical harvester. With reference to FIG. 6, another exemplary mechanical harvester 600 is depicted with an air blower 604 and manifold 606 attached to framework 602. Air blower 604 is configured to provide an air stream that blows at least some of the fallen berries away from the gap that forms between the adjacent belts when the trunk of a bush is present between the belts. As depicted in FIG. 6, in this exemplary embodiment, air blower 604 is attached to manifold 606. Air blower 604 is configured to provide the air stream and air manifold 606 is configured to direct the air stream to alter the trajectory of the falling berries, from a straight line fall to a diverted path away from the gap onto the collectors.

As depicted in FIG. 6, in this exemplary embodiment, air blower 604 and air manifold 606 are positioned near collectors 612 and 622. Additionally, air manifold 606 as depicted in FIG. 6 is angled to provide a horizontal air stream. It should be understood, however, in other exemplary embodiments, the air blower may be positioned closer to or further away from the collectors. The air manifold may also be angled to minimize the loss of the berries falling through the gap onto the ground. In other exemplary embodiments, the air blower may be positioned and angled to provide an air stream, without the air manifold.

The velocity of the air stream may also vary to minimize the damage to the fallen berries. For example, the air blower may be configured to provide a high velocity air stream that balances the minimizing of the damage to the fallen berries and the reduction in the loss of berries to the ground. Further, although FIG. 6 depicts one air blower, it should be understood that in other exemplary embodiments, one or more additional air blowers may be attached to framework 602. For example, a second air blower may be attached to framework 602, configured to provide an air stream from the opposite direction as the first air blower (as depicted in FIG. 6).

With reference again to FIGS. 1A and 1B, the collectors, spring elements, pulleys and belts of mechanical harvester 100 are configured to come into contact with the bushes below the initial row of the branches. It should be understood that the height of the collectors, spring elements, pulleys and belts may be varied based on the average heights of the bushes in a given row or the field.

While FIGS. 1A, 1B, 4A and 4B depict the contact of one berry bush with mechanical harvester 100, it should be understood that more than one bush may be positioned between the belts of the mechanical harvester at a given time. Moreover, while mechanical harvester 100 is depicted to collect berries from one row of bushes, it should be understood that the mechanical harvester may have multiple systems of collectors, spring elements, pulleys and belts to collect berries from multiple rows of berry bushes simultaneously.

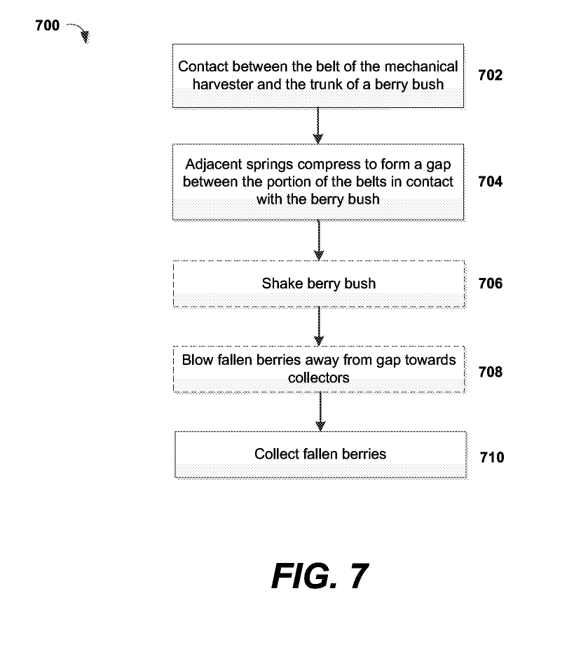

Provided herein is also a method for harvesting berries in a field used the mechanical harvested described above. With reference to FIG. 7, process 700 depicts an exemplary process for harvesting berries from a berry bush in the field. In step 702, mechanical harvester 100 comes into contact with a berry bush in the field. Specifically, adjacent portions of the belts come into contact with the trunk of the berry bush. In step 704, adjacent spring elements, connected to the portions of the belts in contact with the trunk, compress to create a gap between the first and second belts in contact with the trunk of the berry bush. The contact between the belts and the trunk of the berry bush causes berries on the branches of the bush to fall onto the collectors. In optional step 706 (depicted in dotted lines), the mechanical harvester can be configured with a shaking apparatus to gently shake the berry bush, causing more berries to fall onto the collectors. Additionally, in optional step 708 (depicted in dotted lines), the mechanical harvester may be configured with one or more air blowers, configured to provide an air stream that blows at least some of the fallen berries away from the gap towards the first or second collector. In step 710, the fallen berries are collected by the collectors.

The berries collected on the collectors may be deposited into a storage bin, or transported to a processing platform or station for further processing. Processing steps may include, for example, sorting, washing, and packaging the harvested berries.

The foregoing descriptions of specific embodiments have been presented for purposes of illustration and description. They are not intended to be exhaustive, and it should be understood that many modifications and variations are possible in light of the above teaching.

What is claimed is:

1. A mechanical harvester for harvesting berries from a bush in a field, the bush having a trunk, branches connected to the trunk, and berries attached to the branches, the mechanical harvester comprising:
a framework;
a first collector, configured to collect berries fallen from branches of a bush;
a first spring element, connected to the framework and the first collector;
a first pulley, connected to the first spring element and the first collector;
a first belt, wherein the first belt has an inner face and an outer face, and wherein a portion of the inner face of the first belt is in contact with the first pulley;
a second collector, configured to collect berries fallen from branches of the bush;
a second spring element, connected to the framework and the second collector;
a second pulley, connected to the second spring element and the second collector; and
a second belt, wherein the second belt has an inner face and an outer face, wherein a portion of the inner face of the second belt is in contact with the second pulley, and the outer face of the first belt is adjacent to the outer face of the second belt,
wherein, when the trunk of a bush is in contact with a portion of the outer face of the first belt and an adjacent portion of the outer face of the second belt, the first spring element and the second spring element are each configured to independently compress and create a gap between the portion of the outer face of the first belt and the adjacent portion of the outer face of the second belt in contact with the trunk.

2. The mechanical harvester of claim 1, further comprising:
a shaking apparatus, connected to the framework, configured to shake the bush in contact with the first belt and the second belt.

3. The mechanical harvester of claim 2, wherein the shaking apparatus comprises:
a first shaking unit and a second shaking unit,
wherein each shaking unit comprises one or more rod clusters connected to a support column,
wherein each rod cluster comprises a plurality of rods radially attached to a rotating unit on the support column, and
wherein, when the bush is in contact with the shaking apparatus, one or more rod clusters are configured to shake the bush by independently rotating around the support column to which the rod cluster is connected.

4. The mechanical harvester of claim 1, further comprising:
one or more air blowers, each connected to the framework, each configured to provide an air stream that blows at least some of the fallen berries away from the gap towards the first or second collector.

5. The mechanical harvester of claim 1, further comprising:
a conveyor, connected to the framework, configured to transport the fallen berries collected on the first collector and the second collector to a processing area or a packaging area.

6. The mechanical harvester of claim 1, further comprising:
a third collector, configured to collect berries fallen from branches of the bush;
a third spring element, connected to the framework and the third collector;
a third pulley, connected to the third spring element and the third collector, and wherein a portion of the inner face of the first belt is in contact with the third pulley;
a fourth collector, configured to collect berries fallen from branches of the bush;
a fourth spring element, connected to the framework and the fourth collector; and
a fourth pulley, connected to the fourth spring element and the fourth collector, wherein a portion of the inner face of the second belt is in contact with the fourth pulley.

7. The mechanical harvester of claim 1, wherein a portion of the first collector overlaps with a portion of the second collector, and wherein a portion of the second collector overlaps with a portion of the fourth collector.

8. The mechanical harvester of claim 1, wherein each of the first collector and the second collector comprises air vents.

9. The mechanical harvester of claim 1, wherein each of the first collector and the second collector is a collector plate.

10. The mechanical harvester of claim 1, wherein each of the first collector and the second collector is formed of a pliable material.

11. The mechanical harvester of claim 1, wherein each of the first belt and the second belt is formed of a pliable material.

12. The mechanical harvester of claim 1, wherein the berries are blueberries, raspberries, or blackberries.

13. A mechanical method for harvesting berries from a bush in a field, the bush having a trunk, branches connected to the trunk, and berries attached to the branches, wherein the mechanical harvester comprises:
a framework;
a first collector;
a first spring element, connected to the framework and the first collector;
a first pulley, connected to the first spring element and the first collector;
a first belt, wherein the first belt has an inner face and an outer face, and wherein a portion of the inner face of the first belt is in contact with the first pulley;
a second collector;
a second spring element, connected to the framework and the second collector;
a second pulley, connected to the second spring element and the second collector; and
a second belt, wherein the second belt has an inner face and an outer face, wherein a portion of the inner face of the second belt is in contact with the second pulley, and wherein the outer face of the first belt is adjacent to the outer face of the second belt,
the method comprising:
contacting a portion of the outer face of the first belt and an adjacent portion of the outer face of the second belt with the trunk of the bush;
compressing the first spring element and the second spring element independently to create a gap between the portion of the outer face of the first belt and the adjacent portion of the outer face of the second belt in contact with the trunk of the bush, wherein the contacting causes berries on the branches of the bush to fall onto the first collector and the second collector; and
collecting the fallen berries.

14. The method of claim 13, wherein the mechanical harvester further comprises a shaking apparatus, connected to the framework,
wherein the method further comprises shaking the bush to cause at least some of the berries on the branches of the bush to fall onto the first collector and the second collector.

15. The method of claim 13, further comprising:
one or more air blowers, each connected to the framework, and each configured to provide an air stream that moves at least some of the fallen berries away from the gap towards the first or second collector,
wherein the method further comprises blowing at least a portion of fallen berries away from the gap towards the first and second collectors.

16. The method of claim 13, further comprising transporting the fallen berries collected on the first collector and the second collector to a processing area, a packaging area, or a combination thereof.
